(19) United States
(12) Patent Application Publication
(10) Pub. No.: US 2025/0030243 A1
(43) Pub. Date: Jan. 23, 2025

(54) DISTRIBUTION TRANSFORMER AND SYSTEM FOR PROVIDING ELECTRICAL POWER FROM A SOURCE GRID TO CUSTOMER SITES

(71) Applicant: EPCOR DISTRIBUTION & TRANSMISSION INC., Edmonton (CA)

(72) Inventors: Shane Levi FRASER, Edmonton (CA); Christopher Terry CHAPELSKY, Edmonton (CA); Michael Arend SMEDING, St. Albert (CA)

(21) Appl. No.: 18/468,413

(22) Filed: Sep. 15, 2023

(30) Foreign Application Priority Data
Jul. 21, 2023 (CA) 3207509

(51) Int. Cl. H02J 3/14

(52) U.S. Cl. CPC H02J 3/144

(57) ABSTRACT

A distribution transformer for use in a providing electrical power to sites, includes a ferromagnetic core; a primary winding configured to be connected to a source grid at source grid voltage; and a secondary winding configured to be coupled to service cables to supply electrical energy to at least one of the sites at a first line voltage and at least another of the sites at a second line voltage, wherein the second line voltage is higher than the first line voltage.

### FIELD OF TECHNOLOGY

The present disclosure relates to the distribution of electrical power from a source grid to residential sites.

### BACKGROUND

Increased use of electrical energy in homes and businesses is resulting in the transfer of greater quantities of electricity to customer sites, including residential sites. High voltage electricity is distributed through a source grid. A distribution transformer is utilized near residential sites, for example, for connecting to the source grid and providing electrical energy to the nearby residential sites at lower voltage than that found in the source grid. The distribution transformer provides the electrical energy by secondary conductors, also referred to as service cables, connecting the distribution transformer to the residential sites at line voltages of 120V, for example, to provide 120V/240V service to each residential site.

The service cables connecting to the residential sites include a conductive metallic material, referred to as a conductor, wrapped in an insulating jacket. The type and size of the conductor and insulation are primary factors in determining upper limits of current and voltage of the conductor. Other environmental factors may reduce the energy transfer capacity of the conductor.

With increasing demand for electrical energy at residential sites, the service cables that were previously sufficient to provide the electricity required, may no longer be sufficient. To keep up with demand, the service cables, which are often located underground, are replaced with larger service cables that are capable of higher current to provide greater amounts of electricity to the residential sites. For example, 1/0 site entry cables that were previously sufficient to provide 100 A service to a residence may no longer be sufficient and may be replaced with 4/0 site entry cables to provide 200 A service.

Due to the length, landscaping, and civil infrastructure adjacent and over buried distribution conductors, the complexity and cost to replace the service cables is burdensome, costing billions of dollars each year, over the coming decades.

Improvements in the distribution of electrical power to residential sites are desirable.

### SUMMARY

According to one aspect of an embodiment, there is provided a distribution transformer for use in a providing electrical power to sites. The distribution transformer includes a ferromagnetic core; a primary winding configured to be connected to a source grid at source grid voltage; and a secondary winding configured to be coupled to service cables to supply electrical energy to at least one of the sites at a first line voltage and at least another of the sites at a second line voltage, wherein the second line voltage is higher than the first line voltage.

According to another aspect of an embodiment, there is provided a system for connecting a source grid to residential sites including a first residential site and second residential site. The system includes a distribution transformer for use in a providing electrical power, the distribution transformer having at least one primary voltage connection to the source grid at source grid voltage, and secondary voltage connections providing electrical energy to the first residential site and to the second residential site, a first set of service cables connecting the secondary voltage connections to a first residential site at residential line voltages for residential service at the first residential site, and a second set of service cables connecting the secondary voltage connections to the second residential site, at a higher line voltage than the residential line voltages for stepping down at the residential site.

According to still another aspect of an embodiment, there is provided a method of delivering electrical energy from a source grid to residential sites including a first residential site and second residential site. The method includes utilizing a distribution transformer, stepping down from a grid voltage to line voltages of 120V along a first set of service cables and providing 120V/240V service to the first residential site, and utilizing the distribution transformer, stepping down from the grid voltage to 480V along a second set of service cables to provide 480V and 100 A for stepping down at the second residential site.

### BRIEF DESCRIPTION OF THE DRAWINGS

Embodiments of the present disclosure will now be described, by way of example only, with reference to the attached figures, in which:

FIG. 1 is a schematic diagram of an electrical system of the prior art;

FIG. 2 is a schematic diagram of an electrical system in accordance with one example of an embodiment;

FIG. 3 is a front view of one example of a distribution transformer in accordance with an aspect of an embodiment;

FIG. 4 is a sectional side view of the distribution transformer in accordance with an aspect of an embodiment;

FIG. 5 is a schematic diagram illustrating an example of a distribution transformer in accordance with an aspect of an embodiment;

FIG. 6 is a schematic diagram illustrating another example of a distribution transformer in accordance with an aspect of an embodiment;

FIG. 7 is a schematic diagram illustrating another example of a distribution transformer in accordance with an aspect of an embodiment;

FIG. 8 is a schematic diagram illustrating still another example of a distribution transformer in accordance with an aspect of an embodiment; and

FIG. 9 is a schematic diagram illustrating yet another example of a distribution transformer in accordance with an aspect of an embodiment.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

As indicated above, the service cables providing electrical connection to existing residences are limited based on the type and size of the conductor and insulation as well as environmental factors. For example, the limits of the service cables may depend on whether the service cables are directly buried or in an underground duct, the depth at which the cables are buried, the soil thermal resistivity, whether the service cables are bundled with other conductors, the proximity to other conductors or heat sources, the diversity of the load and load factor, ambient temperature, ground temperature, and other factors.

The service cables in many instances, are not sufficient to provide higher current to the residence. The voltage limits, however, may be sufficiently high such that the voltage rating of the service cables substantially exceeds the voltage utilized at the residential site. In the past, a size of a service cable was determined by matching to the current provided to the residential site. With greater demand for electricity, the voltages are kept the same and the current is increased, which resulted in the replacement of the service cables.

The distribution transformer to which the service cables are connected, transforms the high voltage electricity from the source grid to one or two lower secondary voltage(s) utilized at the residential sites. This is achieved using a primary and secondary winding structure of a number of turns of an electrical conductor which are wound on a ferromagnetic core. The same lower secondary voltages are provided to all residential sites connected to the transformer. To change the voltage for one residential site would necessitate either changing the secondary voltages for all residential sites, or utilizing separate distribution transformers.

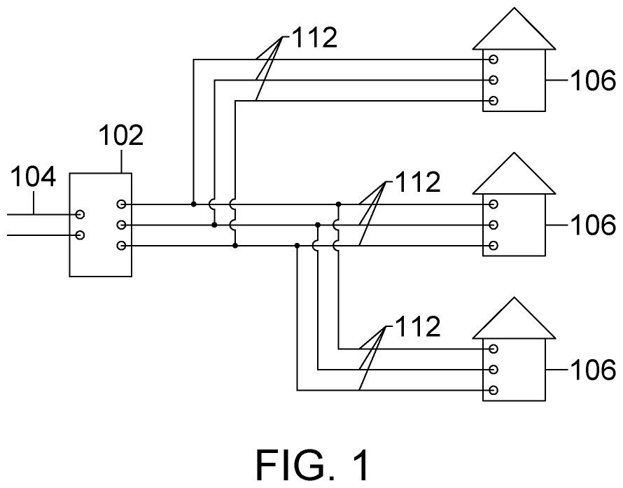

FIG. 1 is a schematic diagram illustrating an electrical system of the prior art in which a distribution transformer 102 connects a source grid 104 to three residential sites 106. The distribution transformer includes a primary winding connected to the source grid 104 at a source grid voltage of 15/25 kV, and a secondary winding around the core for providing electrical energy to the first residential site at line voltages of 120V. Respective service cables 112 connect the secondary winding to each of the residential sites 106 and provide 120/240V and 100 amp service at each residential site 106.

Rather than replacing service cables or installing multiple transformers, a single distribution transformer according to the present disclosure provides three or more secondary voltages to different residential sites at the same time. One set of voltages may be equal to the original or typical voltages distributed to residential sites, while other higher voltages are provided to facilitate the transfer of greater amounts of electricity to one or more other residential sites. Thus, a greater quantity of electricity may be provided utilizing existing service cables to the residential sites.

A site transformer is then utilized at each residential site to which these other higher voltages are provided. The site transformer is connected to the service cables at the residential site and is utilized to reduce the voltage to the residential voltage, for example and to provide a higher current than previously provided to the residence.

Accordingly, an electrical system for connecting a source grid to residential sites including a first residential site and second residential site, includes a distribution transformer for use in a providing electrical power. The distribution transformer has a ferromagnetic core, a primary winding around the core for connection to the source grid at source grid voltage, and a secondary winding around the core for providing electrical energy to the first residential site at line voltages of 120V and to the second residential site at a line voltage of 480V. A first set of service cables connect the secondary winding to the first residential site at line voltages of 120V, and provide 100 amp service at 120V and 240V at the first residential site. A second set of service cables connect the secondary winding to the second residential site, at a line voltage of 480V and current of 100 A. A site transformer including a site core, a site primary winding around the site core may be coupled to the second set of service cables, and a site secondary winding around the site core coupled to site cables to provide 200 amp service at 120V and 240V at the second residential site.

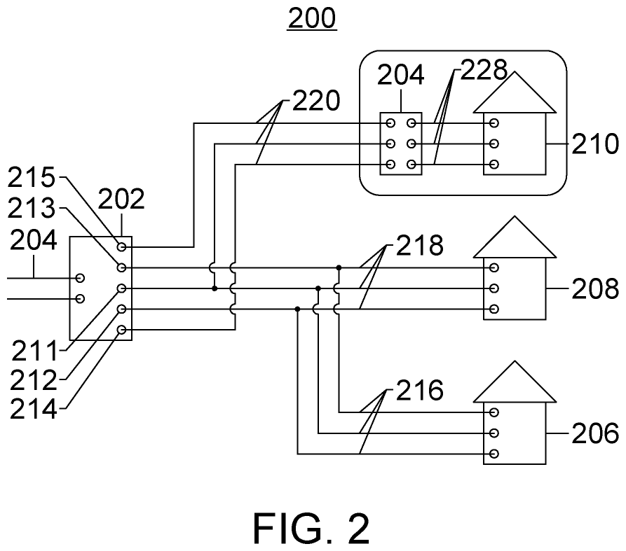

Reference is made to FIG. 2, which shows an electrical system 200 in accordance with one example of an embodiment. The electrical system 200 includes a distribution transformer 202 that connects the source grid 204 to residential sites, which in the present example, includes three residential sites, referred to as a first residential site 206, a second residential site 208, and a third residential site 210.

The distribution transformer 202 may be any suitable distribution transformer. The distribution transformer 202 is connected to the source grid 204 at source grid voltage, which may be in the range of about 15 kV to 25 kV. Other grid voltages such as 5 kV, 8 kV, 35 kV or any other suitable grid voltage may be possible. The distribution transformer 202 also includes connectors 211, 212, 213, 214, 215 for providing electrical energy to the first residential site 206, second residential site 208, and third residential site 210. Other distribution transformers may be successfully employed.

A first set of service cables 216 connects the distribution transformer 202 to the first residential site 206 at line voltages for use at the residential site. The line voltages may be, for example, 120V, providing 120V/240V and 100 A service at the first residential site 206.

A second set of service cables 218 connects the distribution transformer 202 to the second residential site 208 at line voltages for use at the residential site. The line voltages may be, for example, 120V, providing 120V/240V and 100 A service at the second residential site 208.

A third set of service cables 220 connects the distribution transformer 202 to the third residential site 210 at a higher line voltage than that of the first set of service cables 216 and the second set of service cables 218. The third set of service cables 220 may provide electrical connection at a line voltage of 480V and 100 A.

A site transformer 224 includes a site primary winding and a site secondary winding around a site core, and is utilized to convert the higher line voltage of, for example, 480V to residential voltages of, for example, 120/240, but at 200 A. The site primary winding is connected to the third set of service cables 220 to take in electricity from the distribution transformer. Site cables 228 are connected to the site secondary winding to distribute electricity at the third residential site 210 at a lower voltage than the voltage received via the service cables 220 and higher current.

The site transformer 224 may be, for example, a 50 kVA isolation Transformer—240/480V Primary—120/240V Secondary—Single Phase.

Thus, the use of the distribution transformer 202 and site transformer 224 facilitates electric power distribution to residential sites at different voltages, including line voltages of, for example, 120V providing 100 A service to one or more of the residential sites, while also providing a higher voltage of, for example, 480V at a current of 100 A to one or more other residential sites. The site transformer 224 receives the higher voltage and provides lower voltages of, for example, 120V/240V and higher current of 200 A at the residential site.

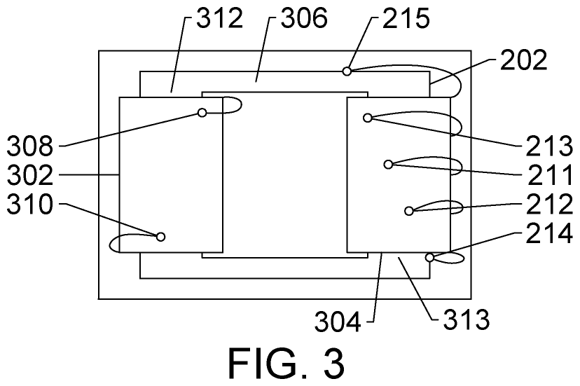

A front view of an example of a distribution transformer 202 in accordance with an embodiment is shown in FIG. 3. In the present example, the distribution transformer 202 includes a primary winding 302 and a secondary winding 304 around a ferromagnetic core 306. Primary voltage connectors 308, 310 are utilized to connect to the primary winding 302 that is wound around one leg 312 of the ferromagnetic core 306. Although two primary voltage connectors 308, 310 are illustrated, optionally, a single primary voltage connector may be utilized to connect to the primary winding 302 and a further connector utilized to connect to ground.

The secondary voltage connectors 211, 212, 213, 214, 215 are utilized to connect to the secondary winding 304 that is wrapped around a second leg 313 of the ferromagnetic core 306.

The primary voltage connectors 308, 310 are connected to the source grid at source grid voltage. The secondary voltage connectors 211, 212, 213, 214, 215 are connected to the first set of service cables 216, the second set of service cables 218, and the third set of service cables 220.

In the examples shown and described, three residential sites are illustrated. The distribution transformer 202 may be utilized to connect to any suitable number of residential sites, however. For example, the distribution transformer 202 may be utilized to connect to about 12 residential sites.

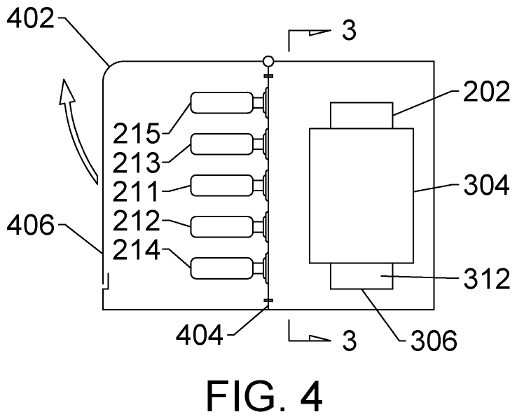

FIG. 4 shows an example of the distribution transformer 202 housed in a housing 402. The distribution transformer 202 includes the secondary voltage connectors 211, 212, 213, 214, 215 that are connected to the secondary winding 304 wrapped around the second leg 312 of the ferromagnetic core 306. The secondary voltage connectors 211, 212, 213, 214, 215 are located on a connection face 404 within the housing 402 and are accessible in the housing 402 via a hinged door 406.

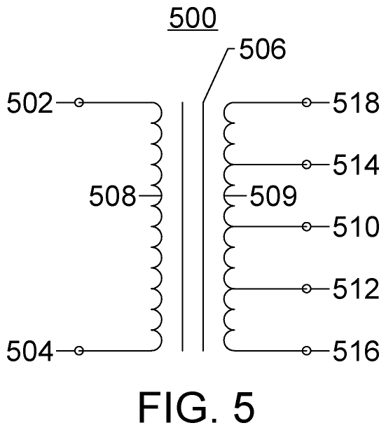

As indicated above, the distribution transformer is not limited to the exact transformer shown in FIG. 3 and FIG. 4. Other distribution transformers may be successfully employed. FIG. 5 through FIG. 9 illustrate examples of the distribution transformer. Different reference numerals are utilized herein to describe each example of the distribution transformer.

In the example of FIG. 5, the distribution transformer is a centre-tapped, single phase transformer 500. The primary voltage connectors 502, 504 are electrically coupled to the primary winding 508 and, are connected to the source grid to provide electricity to the primary winding 508 which is wound around the ferromagnetic core 506.

The secondary winding 509 is also wound around the ferromagnetic core 506 and is subdivided with the connections along the length of the secondary winding 509 to provide different secondary voltages in accordance with Faraday's law of induction, at the secondary voltage connectors 510, 512, 514, 516, 518.

The three center secondary voltage connectors 510, 512, 514 may be utilized for connecting to service cables to provide electricity to residential sites at line voltages for use at the residential sites, for example, providing 120V/240V service at the residential sites.

The outer and middle secondary voltage connectors, 510, 516, 518 may be utilized for connecting to service cables to provide electricity to other residential sites at higher line voltages, for example, providing 480V service.

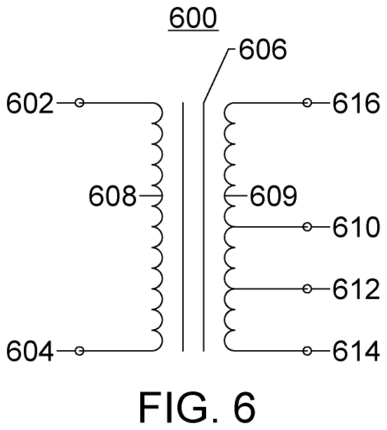

FIG. 6 illustrates another example of a suitable distribution transformer. In this example, the distribution transformer is a single leg split, single phase distribution transformer 600. The primary voltage connectors 602, 604 are electrically coupled to the primary winding 608 and, are connected to the source grid to provide electricity to the primary winding 608 which is wound around the ferromagnetic core 606.

The secondary winding 609 in this example is also wound around the ferromagnetic core 606 and is subdivided with four connections along its length to provide different secondary voltages in accordance with Faraday's law of induction, at secondary voltage connectors 610, 612, 614, 616.

In this example, the three bottom secondary voltage connectors 610, 612, 614 may be utilized for connecting to service cables to provide electricity to residential sites at line voltages for use at the residential sites, for example, providing 120V/240V service at the residential sites.

The uppermost two secondary voltage connectors, 610, 616 may be utilized for connecting to service cables to provide electricity to other residential sites at higher line voltages, for example, providing 480V service.

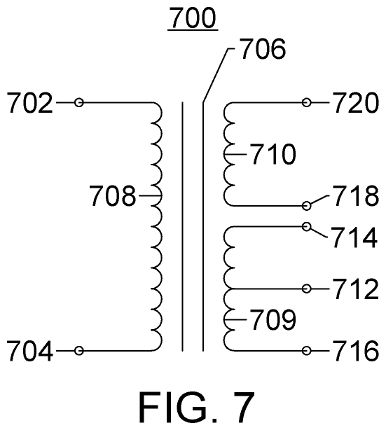

FIG. 7. illustrates another example of a suitable distribution transformer. In this example, the distribution transformer is a tertiary, single phase distribution transformer 700. The primary voltage connectors 702, 704 are electrically coupled to the primary winding 708 and, are connected to the source grid to provide electricity to the primary winding 708 which is wound around the ferromagnetic core 706.

The secondary winding includes two windings 709, 710 that are wound around the ferromagnetic core 706. A first secondary winding 709 is subdivided with connections along its length to provide different secondary voltages in accordance to Faraday's law of induction, at secondary voltage connectors 712, 714, 716. A second secondary winding structure 710 has connections at its' ends to provide a single secondary voltage at secondary voltage connectors 718, 720.

In this example, the three bottom secondary voltage connectors 712, 714, 716 in the figure may be utilized for connecting to service cables to provide electricity to residential sites at line voltages for use at the residential sites, for example, providing 120V/240V service at the residential sites.

The upper two secondary voltage connectors 718, 720 may be utilized for connecting to service cables to provide electricity to other residential sites at higher line voltages, for example, providing 480V service.

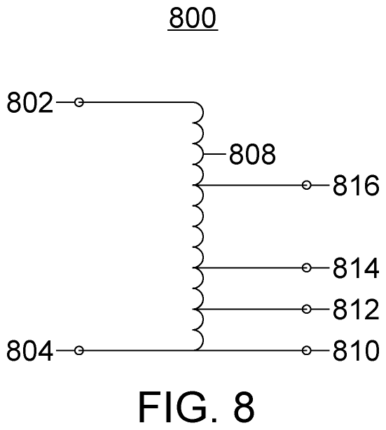

FIG. 8 shows yet another example of a suitable distribution transformer. In this example, the distribution transformer is a single phase tapped autotransformer 800. The primary voltage connectors 802, 804 are electrically coupled to the sole winding 808, and are connected to the source grid to provide electricity to the winding 808 which is wound around a ferromagnetic core.

The sole winding structure 808 is subdivided with connections along its length to provide different secondary voltages in accordance to Faraday's law of induction at the secondary voltage connectors 810, 812, 814, 816, respectively.

In the example as shown, the three lower secondary voltage connectors 810, 812, 814 may be utilized for connecting to service cables to provide electricity to residential sites at line voltages for use at the residential sites, for example, providing 120V/240V service at the residential sites.

The upper secondary voltage connector 816 may be utilized for connecting to service cables to provide electricity to other residential sites at higher line voltages, for example, providing 480V service.

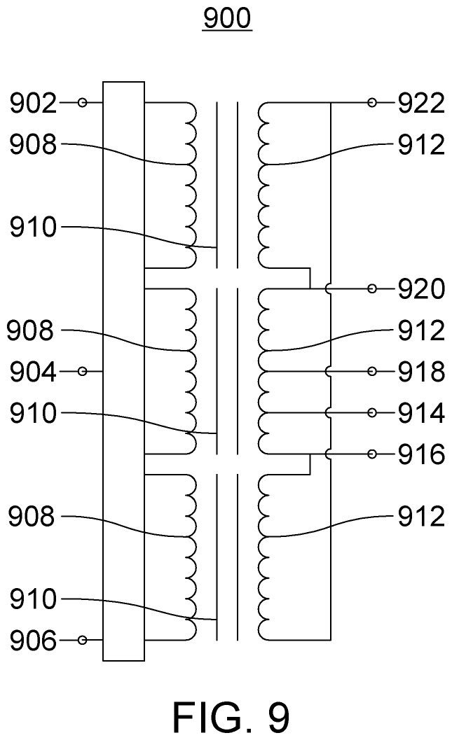

FIG. 9. shows a further example of a suitable distribution transformer. In this example, the distribution transformer is a three phase distribution transformer 900. Primary voltage connectors 902, 904, 906 are electrically coupled to primary windings 908 which may be in a delta or wye configuration, and are connected to the source grid to provide electricity to the primary windings 908 which are wound around ferromagnetic cores 910.

Secondary windings 912 are wound around a respective one of the ferromagnetic cores 910. The secondary windings 912 in the present example are interconnected in a delta configuration with connections at interconnection points of the secondary windings 912 and one of the secondary windings is subdivided with connections along its length. The connections provide different voltages at the connectors 914, 916, 918, 920, 922.

In the example as illustrated, the three lower center secondary voltage connectors 914, 916, 918 may be utilized for connecting to service cables to provide electricity to residential sites at line voltages for use at the residential sites, for example, providing 120V/240V service at the residential sites.

The upper two secondary voltage connectors 920, 922 may be utilized for connecting to service cables to provide electricity to other residential sites at higher line voltages, for example, providing 480V service.

Advantageously, a distribution transformer according to the present disclosure provides three or more secondary voltages to different residential sites at the same time. One set of voltages may be equal to the original or typical voltages distributed to residential sites, while other higher voltages are provided to facilitate the transfer of greater amounts of electricity to one or more other residential sites. Thus, a greater quantity of electricity may be provided utilizing existing service cables to the residential sites.

The scope of the claims should not be limited by the preferred embodiments set forth in the examples, but should be given the broadest interpretation consistent with the description as a whole.

What is claimed is:

1. A distribution transformer for use in a providing electrical power to sites, the distribution transformer comprising:
a ferromagnetic core;
a primary winding configured to be connected to a source grid at source grid voltage;
a secondary winding configured to be coupled to service cables to supply electrical energy to at least one of the sites at a first line voltage and at least another of the sites at a second line voltage, wherein the second line voltage is higher than the first line voltage.

2. The distribution transformer according to claim 1, wherein the service cables include a first set of service cables to supply electrical energy to a first one of the sites at the first line voltage, and wherein the first line voltage is 120V.

3. The distribution transformer according to claim 2, wherein the service cables include a second set of service cables to supply electrical energy to a second one of the sites at the second line voltage, and wherein the second line voltage is 480V.

4. The distribution transformer according to claim 1, wherein the secondary winding is configured to be coupled to a first plurality of the sites utilizing respective sets of the service cables to supply electrical energy at 480V.

5. The distribution transformer according to claim 4, wherein the secondary winding is configured to be coupled to a second plurality of the sites utilizing respective sets of the service cables to supply electrical energy at line voltages of 120V.

6. A system for connecting a source grid to residential sites including a first residential site and second residential site, the system comprising:
a distribution transformer for use in a providing electrical power, the distribution transformer having at least one primary voltage connection to the source grid at source grid voltage, and secondary voltage connections providing electrical energy to the first residential site and to the second residential site;
a first set of service cables connecting the secondary voltage connections to a first residential site at residential line voltages for residential service at the first residential site;
a second set of service cables connecting the secondary voltage connections to the second residential site, at a higher line voltage than the residential line voltages for stepping down at the residential site.

7. The system according to claim 6, wherein the first set of service cables connects the secondary voltage connections to the first residential site at residential line voltages of 120V, providing 120V/240V service.

8. The system according to claim 7, wherein the second set of service cables connects the secondary voltage connections to the second residential site at the higher line voltage of 480V, providing 480V and 100 amperes to the residential site.

9. The system according to claim 6, comprising a site transformer including a site core, a site primary winding around the site core and coupled to the second set of service cables, and a site secondary winding around the site core and coupled to site cables providing service at the second residential site.

10. The system according to claim 9, wherein the site cables connect the site transformer to the second residential site at residential line voltages of 120V, providing 120V/240V and 200 amp service to the second residential site.

11. The system according to claim 9, wherein the system is utilized to connect to further residential sites, and the system comprises further sets of service cables, each further set of service cables connecting the secondary winding to respective ones of the further residential sites.

12. The system according to claim 11, wherein the further sets of service cables include further first sets of cables that connect the secondary winding to ones of the further residential sites, at line voltages of 120V, and provide 120V/240V service at the respective residential sites.

13. The system according to claim 11, wherein the further sets of service cables include further second sets of cables that connect the secondary winding to respective other ones of the further residential sites, each at respective line voltages of 480V.

14. The system according to claim 13, comprising a plurality of further site transformers each having a further primary winding connected to a respective one of the further second sets of service cables, and a further secondary winding coupled to further site cables providing 120V/240V and 200 amp service at the respective other ones of the further residential sites.

15. A method of delivering electrical energy from a source grid to residential sites including a first residential site and second residential site, the method comprising:
utilizing a distribution transformer, stepping down from a grid voltage to line voltages of 120V along a first set of service cables and providing 120V/240V service to the first residential site;
utilizing the distribution transformer, stepping down from the grid voltage to 480V along a second set of service cables to provide 480V and 100 A for stepping down at the second residential site.

16. The method according to claim 15, comprising utilizing a site transformer, stepping down from the 480V and 100 A along the second set of service cables, to line voltages of 120V along second site cables and providing 120V/240V and 200 A service to the second residential site.

17. The method according to claim 16, comprising upgrading to 200 A service by stepping down from the grid voltage to 480V along the first set of service cables to provide 480V and 100 A to the first residential site.

18. The method according to claim 17, comprising adding a further site transformer at the first residential site and, utilizing the further site transformer, stepping down from the 480V and 100 A to line voltages of 120V along first site cables and providing 120V/240V and 200 A service to the first residential site.

19. The method according to claim 18, comprising utilizing existing site service entry cables as the second set of service cables to provide 480V and 100 A for stepping down at the second residential site.
